(19) United States
(12) Patent Application Publication
(10) Pub. No.: US 2016/0142324 A1
(43) Pub. Date: May 19, 2016

(54) Diameter Message Throttling

(71) Applicant: ALCATEL-LUCENT CANADA INC., Ottawa (CA)

(72) Inventors: Mike E. Vihtari, Kanata (CA); Peter K. Jorgensen, Nepean (CA); Robert A. Mann, Carp (CA)

(73) Assignee: Alcatel-Lucent Canada Inc.

(21) Appl. No.: 14/546,823

(22) Filed: Nov. 18, 2014

(51) Int. Cl. H04L 12/815; H04L 12/863; H04L 12/741

(52) U.S. Cl. CPC H04L 47/22; H04L 45/74; H04L 47/622

(57) ABSTRACT

Various exemplary embodiments relate to a method performed by a Diameter Routing Agent (DRA) for managing a Diameter queue, the method comprising: identifying throttling rules which dictate the rate at which a message in the Diameter queue will be transmitted; determining throttling rules that are applicable to the message; applying the determined throttling rules to the message; and determining an action to take based upon the applied throttling rules.

### TECHNICAL FIELD

Various exemplary embodiments disclosed herein relate generally to computer networking.

### BACKGROUND

Since its proposal in Internet Engineering Task Force (IETF) Request for Comments (RFC) 3588, the Diameter protocol has been increasingly adopted by numerous networked applications. For example, the Third Generation Partnership Project (3GPP) has adopted Diameter for various policy and charging control (PCC), mobility management, and IP multimedia subsystem (IMS) applications. As IP-based networks replace circuit-switched networks, Diameter is even replacing SS7 as the key communications signaling protocol. As networks evolve, Diameter is becoming a widely used protocol among wireless and wireline communications networks.

One significant aspect of the Diameter protocol is Diameter packet routing. Entities referred to as Diameter routing agents (DRAs) facilitate movement of packets in a network. In various deployments, DRAs may perform elementary functions such as simple routing, proxying, and redirect.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a Diameter Routing Agent (DRA) for managing a Diameter queue, the method including: identifying throttling rules which dictate the rate at which a message in the Diameter queue will be transmitted; determining throttling rules that are applicable to the message; applying the determined throttling rules to the message; and determining an action to take based upon the applied throttling rules.

Various exemplary embodiments are described wherein determining throttling rules further includes: determining which throttling rules are applicable based on at least one from a list of: the message origin, which peer the message arrived from, which peer the message is directed to, and the messages final destination.

Various exemplary embodiments are described wherein determining throttling rules further includes: determining which throttling rules are applicable based on which realm the message originates.

Various exemplary embodiments are described wherein the applicable rules are determined by a user specified maximum number of messages per time period for that realm.

Various exemplary embodiments are described wherein the action taken is at least one from a list of: rejecting the message and dropping the message.

Various exemplary embodiments are described wherein the action taken is quarantining the message when the message is directed to an egress peer.

Various exemplary embodiments are described wherein the action taken is rerouting the message when an alternate route is available and the message is directed to an egress peer.

Various exemplary embodiments are described including a non-transitory machine-readable storage medium encoded with instructions for execution by a Diameter Routing Agent for managing a Diameter queue, the medium including: instructions for identifying throttling rules which dictate the rate at which a message in the Diameter queue will be transmitted; instructions for determining throttling rules that are applicable to the message; instructions for applying the determined throttling rules to the message; and instructions for determining an action to take based upon the applied throttling rules.

Various exemplary embodiments are described for managing a Diameter queue, the DRA including: a rule storage configured to store a throttling rule; a rule engine configured to identify throttling rules which dictate the rate at which a message in the Diameter queue will be transmitted; and a throttling engine configured to: determine throttling rules that are applicable to the message; apply the determined throttling rules to the message; and determine an action to take based upon the applied throttling rules.

Various exemplary embodiments are described wherein in determining throttling rules, the throttling engine is further configured to: determine which throttling rules are applicable based on at least one from a list of: the message origin, which peer the message arrived from, which peer the message is directed to, and the messages final destination.

Various exemplary embodiments are described wherein in determining throttling rules, the throttling engine is further configured to: determine which throttling rules are applicable based on which realm the message originates.

Various exemplary embodiments are described wherein the applicable rules are determined by a user specified maximum number of messages per time period for that realm.

Various exemplary embodiments are described wherein the action to take is at least one from a list of: reject the message and drop the message.

Various exemplary embodiments are described wherein the action to take is quarantine the message when the message is directed to an egress peer.

Various exemplary embodiments are described wherein the action to take is to reroute the message when an alternate route is available and the message is directed to an egress peer.

It should be apparent that, in this manner, various exemplary embodiments enable Diameter message throttling.

### BRIEF DESCRIPTION OF THE DRAWINGS

In order to better understand various exemplary embodiments, reference is made to the accompanying drawings, wherein:

FIG. 1 illustrates an exemplary network environment for a Diameter Routing Agent;

FIG. 2 illustrates an exemplary Diameter network environment for a Diameter Routing Agent;

FIG. 3 illustrates an exemplary Diameter Routing Agent;

FIG. 4 illustrates an exemplary throttling data structure;

FIG. 5 illustrates an exemplary method for throttling Diameter messages; and

FIG. 6 illustrates an exemplary hardware diagram.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

Diameter Routing Agents (DRAB) available today need to protect themselves from gateways and servers which overload them with message requests or request more message passing than allowed. Similarly, it would be desirable to be able to control message passing rates or message throttling to enforce license based services. Additionally, message throttling is desirable on Diameter Routing Agents in order to protect downstream servers or peers.

Referring now to the drawings, in which like numerals refer to like components or steps, there are disclosed broad aspects of various exemplary embodiments.

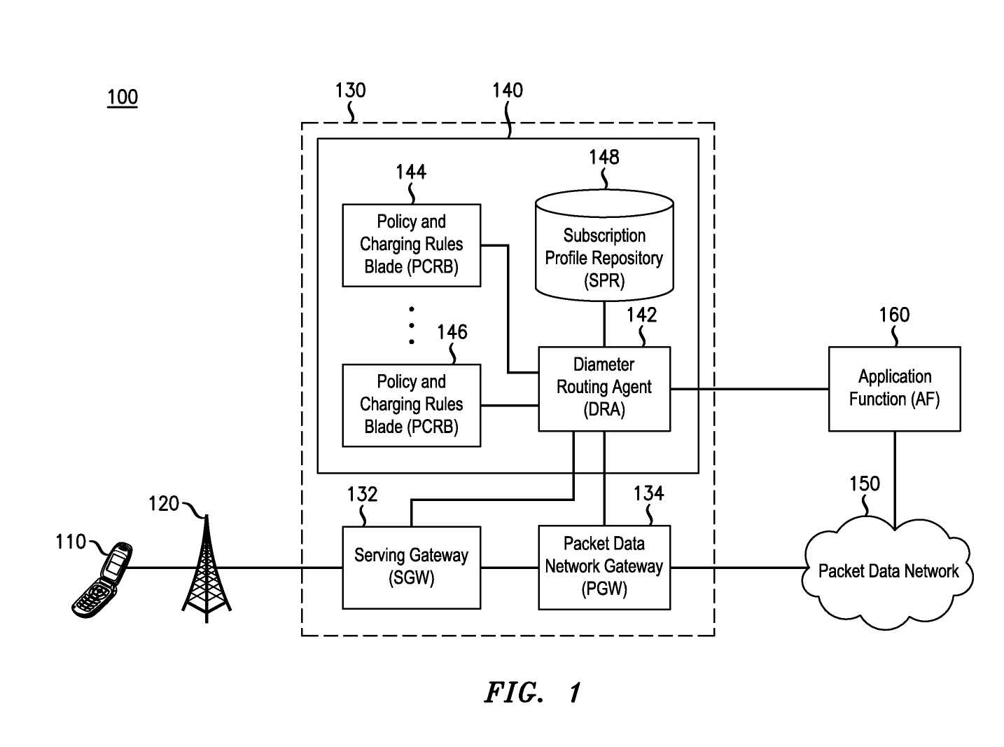

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, packet data network 150, and application function (AF) 160.

User equipment 110 may be a device that communicates with packet data network 150 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository.

As will be described in greater detail below, DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with AF 160 via an Rx interface. As described in further detail below with respect to AF 160, PCRB 144, 146 may receive an application request in the form of an Authentication and Authorization Request (AAR) from AF 160. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 138 may include subscriber information such as identifiers for each subscriber, bandwidth limits, charging parameters, and subscriber priority.

Packet data network 150 may be any network for providing data communications between user equipment 110 and other devices connected to packet data network 150, such as AF 160. Packet data network 150 may further provide, for example, phone or Internet service to various user devices in communication with packet data network 150.

Application function (AF) 160 may be a device that provides a known application service to user equipment 110. Thus, AF 160 may be a server or other device that provides, for example, a video streaming or voice communication service to user equipment 110. AF 160 may further be in communication with the PCRB 144, 146 of the EPC 130 via an Rx interface. When AF 160 is to begin providing known application service to user equipment 110, AF 160 may generate an application request message, such as an authentication and authorization request (AAR) according to the Diameter protocol, to notify the PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within subscriber network 100 and supported by DRA 142. For example, an Rx application may be established between AF 160 and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

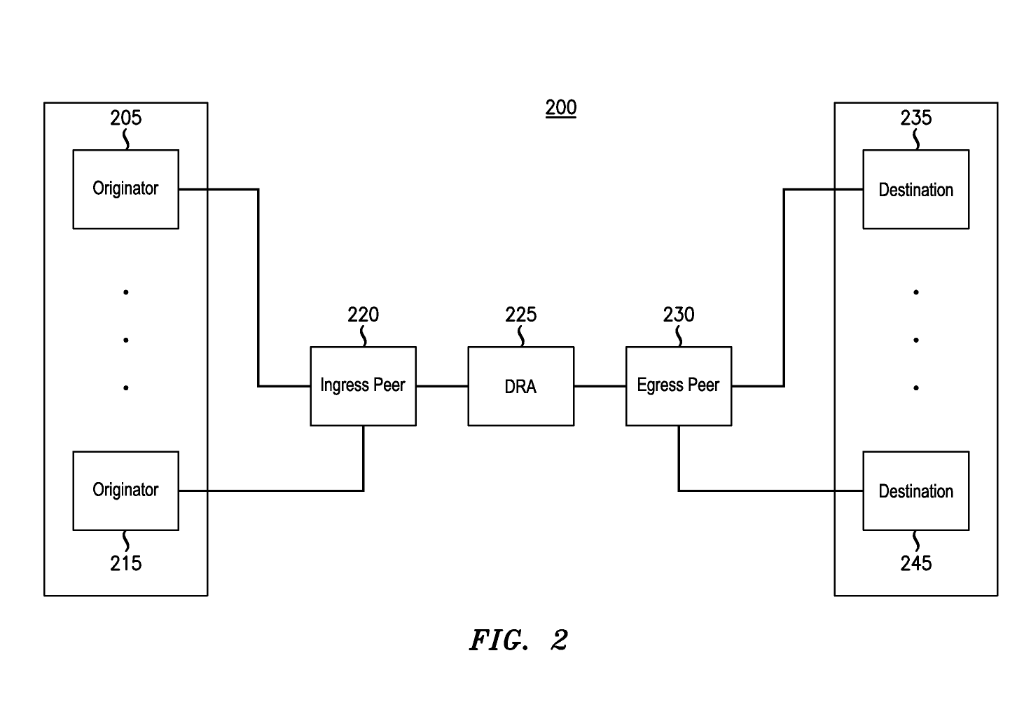

FIG. 2 illustrates an exemplary Diameter network environment 200 for a Diameter Routing Agent. Exemplary network environment 200 may include originators 205, 215, Ingress Peer 220, DRA 225, Egress Peer 230 and Destinations 235, 245. Exemplary network environment 200 may be all or part of evolved packet core 130.

DRA 225 may be any Diameter Routing Agent such as DRA 142. DRA 225 may be attached to ingress peer 220 and/or egress peer 230 and configured to receive and transport Diameter messages from them respectively. DRA 225 may be configured to determine rates at which to route messages received from or to ingress peer 220 and/or egress peer 230 respectively. For example, a user may configure rules on DRA 225 that enable DRA 225 to make decisions dynamically as to what to do with messages dependent on information contained in the messages. Information in the message may include the message origin, which peer the message arrived from, which peer the message is directed to, and/or the messages final destination.

Ingress peer 220 may be any network device that is a next hop to DRA 225. Ingress peer may be any network node or next hop from which DRA receives messages. Ingress peer 220 may be PCRB 144. Similarly ingress peer 220 may be SGW 132. Ingress peer 220 may be configured to receive messages from one of originators 205, 215.

Egress Peer 230 may similarly be any network device that is a next hop to DRA 225. Egress peer 230 may be any network node/next hop to which DRA transmits received messages. Egress peer 230 may similarly be PCRB 144, SGW 132 or PGW 134. Egress peer 230 may be configured to transmit messages to one or more of destinations 235, 245.

Originators 205, 215 or destinations 235, 245 may be any network device that is not directly connected to DRA 225. The originators or destinations may be specified as an entire realm during network definition. In some embodiments originators 205, 214 or destinations 235, 245 may be directly connected to DRA 225.

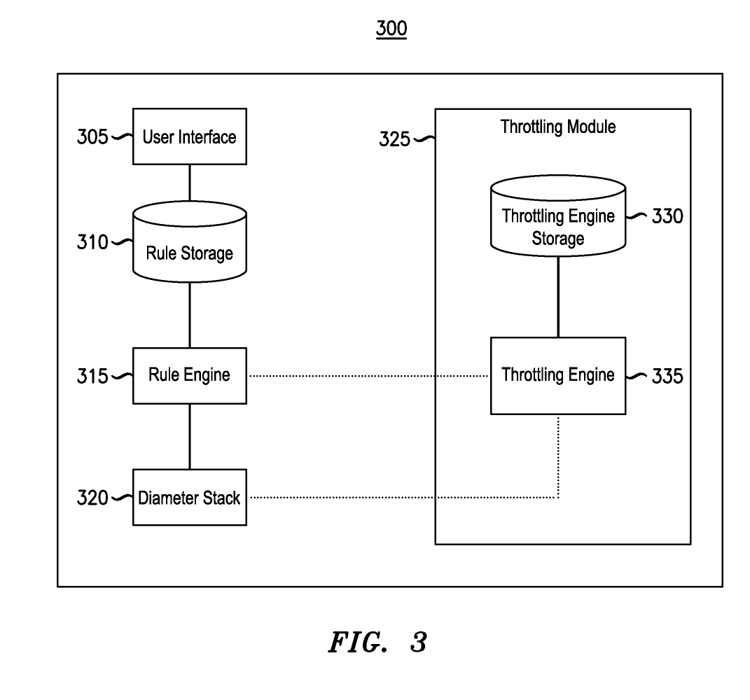

FIG. 3 illustrates an exemplary Diameter Routing Agent (DRA) 300. DRA 300 may include a number of components such as user interface 305, rule storage 310, rule engine 315, Diameter stack 320, throttling engine storage 330, and throttling engine 335.

DRA 300 may be a standalone device or a component of another system. For example, DRA 300 may correspond to DRA 142 of exemplary environment 100. In such an embodiment, DRA 142 may support various Diameter applications defined by the 3GPP such as Gx, Gxx, Rx, or Sp. It will be understood that DRA 300 may be deployed in various alternative embodiments wherein additional or alternative applications are supported. As such, it will be apparent that the methods and systems described herein may be generally applicable to supporting any Diameter applications.

Rule engine 315 may include hardware or executable instructions on a machine readable storage medium configured to process a received message by evaluating one or more rules stored in rule storage 310. As such, rule engine 315 may be a type of processing engine. Rule engine 315 may retrieve one or more throttling rules, evaluate criteria of the throttling rules to determine whether the throttling rules are applicable, and specify one or more result of any applicable rules.

Rule storage 310, may be any machine-readable medium capable of storing one or more rules for evaluation by rule engine 315. Accordingly, Rule storage 310, may include a machine-readable storage medium such as read-only memory (ROM), random-access memory (RAM), magnetic disk storage media, optical storage media, flash-memory devices, and/or similar storage media. In various embodiments, rule storage 310 may store one or more rule sets as a binary decision tree data structure. Various other data structures for storing a rule set will be apparent.

Diameter Stack 320 may include hardware or executable instructions on a machine-readable storage medium configured to exchange messages with other devices according to the Diameter protocol. Diameter stack 320 may include an interface including hardware or executable instructions encoded on a machine readable storage medium configured to communicate with other devices. For example, diameter stack 320 may include an Ethernet or TCP/IP interface. In various embodiments, diameter stack 320 may include multiple physical ports.

Diameter stack 320 may also be configured to read and construct messages according to the Diameter protocol. For example, Diameter stack may be configured to read and construct CCR, CCA, AAR, AAA, RAR, and RAA messages. Diameter stack 320 may provide an application programmer's interface (API) such that other components of DRA 300 may invoke functionality of Diameter stack. For example, rule engine 315 may be able to utilize the API to read an attribute-value pair (AVP) from a received CCR or to modify an AVP of a new CCA. Various additional functionalities will be apparent from on the following description.

Rule storage 310 may be any machine-readable medium capable of storing one or more rules for evaluation by rule engine 315. Accordingly, rule storage 310 may include a machine-readable storage medium such as read-only memory (ROM), random-access memory (RAM), magnetic disk storage media, optical storage media, flash-memory devices, and/or similar storage media. In various embodiments, rule storage 310 may store one or more rule sets as a binary decision tree data structure. Various other data structures for storing a rule set will be apparent.

It will be understood that, while various components are described as being configured to perform functions such as evaluating throttling rules, such configurations may not require any throttling rules to be present in rule storage. For example, rule engine 315 may be configured to evaluate a throttling rule even if no such rule is stored in rule storage 310. Thereafter, if a user adds such a rule to rule storage, rule engine 315 may process the rule as described herein. In other words, as used herein, the phrase “configured to” when used with respect to functionality related to rules will be understood to mean that the component is capable of performing the functionality as appropriate, regardless of whether a rule that requests such functionality is actually present.

User interface 305 may include hardware or executable instructions on a machine-readable storage medium configured to enable communication with a user. As such, User interface 305 may include a network interface (such as a network interface included in Diameter stack 320), a monitor, a keyboard, a mouse, or a touch-sensitive display. User interface 305 may also provide a graphical user interface (GUI) for facilitating user interaction. User interface 305 may enable a user to customize the behavior of the DRA. For example, User interface 305 may enable a user to define rules for storage in rule storage 310 and evaluation by rule engine 315. Various additional methods for a user to customize the behavior of DRA via User interface 305 will be apparent to those of skill in the art.

In some embodiments the throttling engine 335 may be a part of the rule engine Likewise the throttling engine storage 330 may be a part of the rule storage 310.

The contents of Diameter messages may vary depending on the application and command type. For example, an Rx RAA message may include different data from a Gx CCR message. Such differences may be defined by various standards governing the relevant Diameter applications. Further, some vendors may include proprietary or otherwise non-standard definitions of various messages.

Throttling module 325 may include hardware or executable instructions on a machine readable storage medium configured to manage throttling engine 335 and throttling engine storage 330. Throttling engine 335 may use throttling engine storage 330 to store a queue of throttling specific rules. Throttling engine 335 may be used to perform method 500. Throttling engine may determine throttling rules applicable to each Diameter message. Throttling engine may communicate with rule engine 315.

Throttling engine 335 may create a data structure to store throttling rules. Further, throttling engine 335 may store the data structure in throttling engine storage 330. Throttling engine 335 may be responsible for looking up a message's rule and determining what the appropriate action is to take if there is one. Throttling may also apply the actions to the message such as dismissing, rejecting, or quarantining, for example. Similarly, throttling engine 335 may communicate with rule engine 315 and/or diameter stack 320 to notify them what the appropriate action is take, and not directly apply the rule.

It should be noted that while rule storage 310, rule engine 315, Diameter stack 320, throttling engine storage 330 and throttling engine 335 are illustrated as separate devices, one or more of these components may be resident on multiple storage devices. Further, one or more of these components may share a storage device. For example, rule storage 310, rule engine 315, throttling engine storage 330, and throttling engine 335 may all refer to portions of the same hard disk or flash memory device.

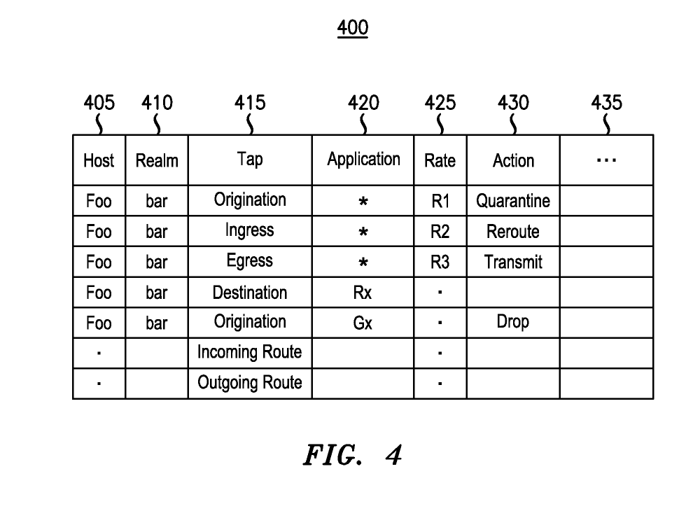

FIG. 4 illustrates an exemplary throttling data structure 400. Throttling data structure 400 may include host data 405, realm data 410, tap data 415, application data 420, rate data 425, action data 430 and additional exemplary data 435.

Throttling data structure 400 represents an exemplary data structure used to store throttling rules and may be a table. The data structure may also include, for example, a binary tree, a database, or a hash table. The data structure may be managed and modified by throttling engine 335. Throttling data structure 400 may also be stored, for example, in throttling engine storage 330.

Throttling data structure 400 may include host data 405. Host data 405 may indicate the name or address of a node. Host data 405 may, for example, indicate a SGW, a PGW or a PCRB as the node requesting a Diameter message to be sent. Similarly, the host data 405 may indicate a SGW, PGW or PCRB as a node intended to receive a Diameter message. Similarly, in some embodiments, DRA 300 may be configured to throttle its own requests and host data 405 may not be used or indicate DRA 300 as the host.

Throttling data structure 400 may include realm data 410. Realm data 410 may include any grouping of devices in the Diameter network. One realm may include, for example, several PCRF blades grouped together. Another realm may include, for example, a DRA grouped with multiple SPR's. A realm may also be a group of servers linked on the Diameter network. A group of Video On Demand servers may also be one realm.

Throttling data structure 400 may include tap data 415. Tap data 415 may include routing information related to the message in the throttling queue. For example, tap data 415 may indicate a rule for a message that is a prior hop ingress peer from which a message was received. Tap data 415 may also include information indicating that for a rule a message is intended for a next hop egress peer. Tap data may similarly indicate that a message is intended for a specific destination or arrived from a specific point of origin. Finally, tap data may include information indicating an incoming route or an outgoing route for the relevant host and realm.

Information in tap data 415 may help in making throttling rules decisions. For example, a rule may be setup for a specific host and realm indicating that if the message is intended for a certain destination and the maximum number of message requests for that destination has been surpassed, then an action may be taken. In this example, rate data 425 may be used to determine if the rate has been surpassed. Similarly, action data 430 may indicate which action to take in the case where a message must be throttled.

Throttling data structure 400 may include application data 420. Application data may include any kind of Diameter applications including Gx, Gxx, Rx, Sx, and S9. Application data 420 may be utilized in the rules determination, application, and action determination. For example, a rule may be set that all Gx messages should be discarded. Another example is that for all Rx messages, over a set rate, peers should be queried for possible alternate routes. Similarly, the application data may be left blank and not have any impact on a throttling rule.

Throttling data structure 400 may include rate data 425. Rate data 425 may be set by a user of the system via a user interface. Similarly, rate data 425 may be set dynamically by a server. A user may set rate data 425, allowing a maximum number of message requests to be transmitted within an indicated time span. The rate data 425 may be set individually for tap data 415. For example, separate rate data may be set for each of ingress peer, egress peer, origination and destination.

Throttling data structure 400 may include action data 430. Action data 430 may indicate what action should be taken when more messages have been requested than allowed by the maximum indicated by the rate data 425. The action taken may be to reject a message request. Similarly, the action may be to reject a message request and notify the requesting entity. Another action to take may include temporarily quarantining message requests and seeking alternate routes. In response to a quarantine, a reroute action may be taken if an alternate route does exist, or maintaining a quarantine if none does. Also, a message may be rerouted if possible. If not, the message may be dropped. Also, wildcards may be used in various entries in the throttling data structure 400.

Throttling data structure 400 may include additional exemplary data 435. Additional exemplary data 435 may include any kind of data, including variations on the data. For example, complex rate rules may be included. Additional actions may be indicated. Similarly, sub-realm rules, for example, may be created. The additional exemplary data 435 may include data collected to determine the current message rates.

The throttling rules may correlate any combination of message host, realm, source of origin, destination and application being utilized. This is an exemplary set of criteria and it will be appreciated by one in the art that other criteria may be accounted for. In correlating, throttling engine 335 may define a throttling rate to be applied and/or an action to take per rule.

For example, a user may set a maximum number of message requests to be transmitted over a specified time span. This rate may be stored in rate data 425. For example, a user may specify that for one host and realm an origination message may be allowed X number of messages per 1 second, 1/10 of 1 second or the like. X may be any number of messages including 0, 1 or 1000, for example. The time span and maximum number of requests may be configured individually for each throttling scenario. Each throttling scenario, which in turn creates a throttling rule, may include a host, realm and one of: message origination source, ingress peer source (prior hop), destination or egress peer (next hop) destination.

The rule may be defined or account for specific applications as well. Applications may be any kind of Diameter applications such as Gx, Rx, Rxx, Sx and S9. The application criteria and data may be stored in application data 420.

The rules may also be defined on any scale. For example, one rule may be defined for an entire realm. Similarly, one rule may be defined for one realm and either a message origination source, ingress peer source, destination or egress peer destination. Also a rule may be defined for one host, regardless of its realm.

In defining the throttling rule, the rule may be added to any kind of data structure which can track the data. The data structures may include, for example, a binary tree, a database, a table or a hash table. The data structure may be exemplary throttling data structure 400, for example. The data structure may also be stored in throttling engine storage 330.

In defining the throttling rule, an action to be applied for that rule may also be defined for each new rule. Action data 430 may include data regarding what action should be taken by the DRA per rule or per set of rules. The action to be taken may include, for example, dropping a message, rejecting a message, quarantine a message and to reroute a message. If a peer or realm has, for example, exceeded their messaging limit they may reject a subsequent message in a queue of diameter messages. Similarly, if a different route is available, than an alternate peer may be utilized. This would benefit in increasing quality of service. Similarly, if certain peers or hosts are overloading the system with too many requests, than a rule may indicate to temporarily refuse service or message routing for that peer or host. Additional actions or more complex rate rules may be additionally be included in additional exemplary data 435.

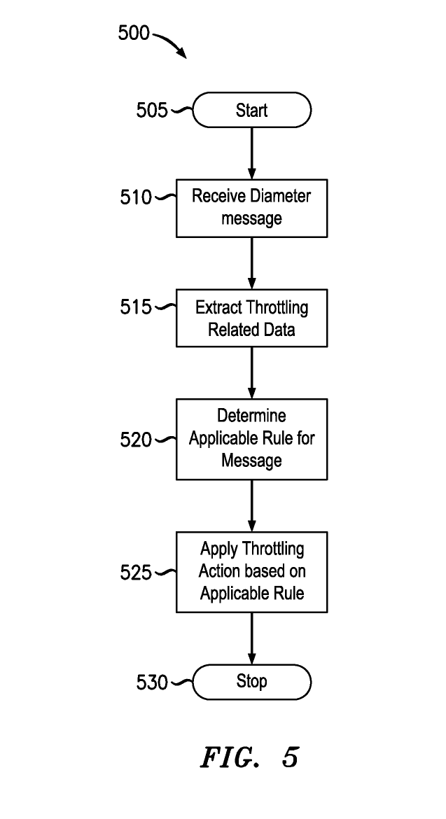

FIG. 5 illustrates an exemplary method for throttling Diameter messages 500. DRA 300, for example, may implement the method 500. The DRA 300 may begin in step 505 and proceed to step 510 where it may receive one or more diameter messages.

DRA 300 may then proceed to step 515, where it may extract the throttling related message data. The extracted information may indicate, for example, that the message originated from an ingress peer, which may be PCRB 144 or SGW 132. The extracted information may also indicate the source of origin. Additionally, the extracted information may be an indication of an intended egress peer or final destination. Egress peer or final destination may be, for example, PGW 134, SGW 132 or PCRB 144. The extracted information may further indicate which host and/or realm message is arriving from or to which it is being transmitted. This data may be stored in host data 405, and realm data 410 respectively.

DRA 300 may then proceed to step 520 where it may identify a throttling rule. The throttling rules may correlate any combination of message host, realm, source of origin, destination and application being utilized.

DRA 300 may then proceed to step 520 where it may determine an applicable rule for the message. In determining an applicable rule for a message, throttling module 325 may determine one or more rules as well as actions that are applicable for a message. Similarly, throttling module may determine a set of rules for a group of messages with similar characteristics. In step 525, the throttling engine may further apply rules to the message or messages that are relevant. The DRA 300 may use a strict set of rules in some embodiments. In other embodiments an order to be followed for the rules may be used. In additional embodiments, a hierarchy of rules may be followed.

DRA 300 may then proceed to step 525 where it may apply a throttling action based on an applicable rule. DRA 300 may determine one rule to apply according to specified criteria. Similarly, multiple rules may be applied and an appropriate action from action data 430. Programming logic and/or instructions may be included or created to determine when and which rules are to be applied.

DRA 300 may then proceed to step 530 where it may cease application for that rule or rule set. DRA may then continue from the beginning at step 505 for another message. DRA may retrieve another message or act on multiple messages at one time and begin exemplary method for throttling Diameter messages 500 again.

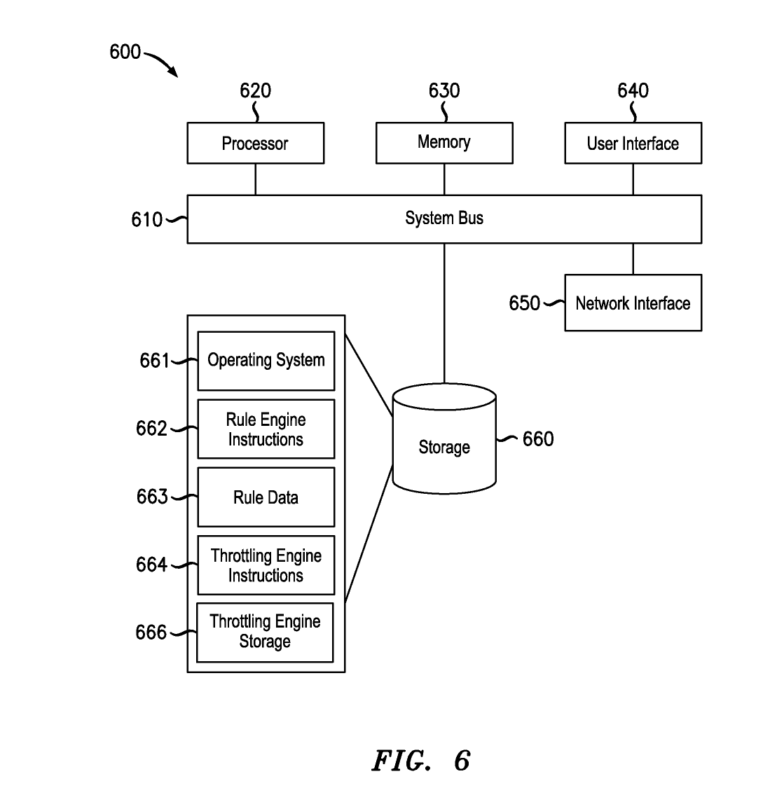

FIG. 6 illustrates an exemplary hardware diagram for a device 600 such as device including a manager in a system. The exemplary device 600 may correspond to DRA of FIG. 3. As shown, the device 600 includes a processor 620, memory 630, user interface 640, network interface 650, and storage 660 interconnected via one or more system buses 610. It will be understood that FIG. 6 constitutes, in some respects, an abstraction and that the actual organization of the components of the device 600 may be more complex than illustrated.

The processor 620 may be any hardware device capable of executing instructions stored in memory 630 or storage 660. As such, the processor may include a microprocessor, field programmable gate array (FPGA), application-specific integrated circuit (ASIC), or other similar devices.

The memory 630 may include various memories such as, for example L1, L2, or L3 cache or system memory. As such, the memory 630 may include static random access memory (SRAM), dynamic RAM (DRAM), flash memory, read only memory (ROM), or other similar memory devices.

The user interface 640 may include one or more devices for enabling communication with a user such as an administrator. For example, the user interface 640 may include a display, a mouse, and a keyboard for receiving user commands.

The network interface 650 may include one or more devices for enabling communication with other hardware devices. For example, the network interface 650 may include a network interface card (NIC) configured to communicate according to the Ethernet protocol. Additionally, the network interface 650 may implement a TCP/IP stack for communication according to the TCP/IP protocols. Various alternative or additional hardware or configurations for the network interface 650 will be apparent.

The storage 660 may include one or more machine-readable storage media such as read-only memory (ROM), random-access memory (RAM), magnetic disk storage media, optical storage media, flash-memory devices, or similar storage media. In various embodiments, the storage 660 may store instructions for execution by the processor 620 or data upon with the processor 620 may operate. For example, the storage 660 may store rule engine instructions 662 for performing Diameter throttling according to the concepts described herein. The storage may also store rule data 663, throttling engine instructions 664 and throttling engine storage 666 for use by the processor executing the rule engine instructions 662.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a Diameter Routing Agent (DRA) for managing a Diameter queue, the method comprising:
receiving a Diameter message;
determining throttling rules that are applicable to the Diameter message;
applying the determined throttling rules to the Diameter message; and
determining an action to take based upon the applied throttling rules.

2. The method of claim 1, wherein determining throttling rules further comprises:
determining which throttling rules are applicable based on at least one from a list of: the message origin, which peer the message arrived from, which peer the message is directed to, and the messages final destination.

3. The method of claim 2, wherein determining throttling rules further comprises:
determining which throttling rules are applicable based on which realm the message originates.

4. The method of claim 1, wherein the applicable rules are determined by a user specified maximum number of messages per time period for that realm.

5. The method of claim 1, wherein the action taken is at least one from a list of:
rejecting the message and dropping the message.

6. The method of claim 1, wherein the action taken is quarantining the message when the message is directed to an egress peer.

7. The method of claim 1, wherein the action taken is rerouting the message when an alternate route is available and the message is directed to an egress peer.

8. A non-transitory machine-readable storage medium encoded with instructions for execution by a Diameter Routing Agent for managing a Diameter queue, the medium comprising:
instructions for receiving a Diameter message;
instructions for determining throttling rules that are applicable to the Diameter message;
instructions for applying the determined throttling rules to the Diameter message; and
instructions for determining an action to take based upon the applied throttling rules.

9. The non-transitory machine-readable storage medium of claim 8, wherein determining throttling rules further comprises:
determining which throttling rules are applicable based on at least one from a list of: the message origin, which peer the message arrived from, which peer the message is directed to, and the messages final destination.

10. The non-transitory machine-readable storage medium of claim 9, wherein determining throttling rules further comprises:
determining which throttling rules are applicable based on which realm the message originates.

11. The non-transitory machine-readable storage medium of claim 8, wherein the applicable rules are determined by a user specified maximum number of messages per time period for that realm.

12. The non-transitory machine-readable storage medium of claim 8, wherein the action taken is at least one from a list of:
rejecting the message and dropping the message.

13. The non-transitory machine-readable storage medium of claim 8, wherein the action taken is quarantining the message when the message is directed to an egress peer.

14. The non-transitory machine-readable storage medium of claim 11, wherein the action taken is rerouting the message when an alternate route is available and the message is directed to an egress peer.

15. A Diameter Routing Agent (DRA) for managing a Diameter queue, the DRA comprising:
a rule storage configured to store a throttling rule;
a rule engine configured to identify throttling rules which dictate the rate at which a message in the Diameter queue will be transmitted; and
a throttling engine configured to:
determine throttling rules that are applicable to the message;
apply the determined throttling rules to the message; and
determine an action to take based upon the applied throttling rules.

16. The DRA of claim 15, wherein in determining throttling rules, the throttling engine is further configured to:
determine which throttling rules are applicable based on at least one from a list of: the message origin, which peer the message arrived from, which peer the message is directed to, and the messages final destination.

17. The DRA of claim 16, wherein in determining throttling rules, the throttling engine is further configured to:
determine which throttling rules are applicable based on which realm the message originates.

18. The DRA of claim 15, wherein the applicable rules are determined by a user specified maximum number of messages per time period for that realm.

19. The DRA of claim 15, wherein the action to take is at least one from a list of:
reject the message and drop the message.

20. The DRA of claim 15, wherein the action to take is quarantine the message when the message is directed to an egress peer.

21. The DRA of claim 15, wherein the action to take is to reroute the message when an alternate route is available and the message is directed to an egress peer.
